(19) United States
(12) Patent Application Publication
(10) Pub. No.: US 2007/0159318 A1
(43) Pub. Date: Jul. 12, 2007

(54) Speed reduction warning system

(76) Inventor: Charles R. Roser, Carmi, IL (US)

Correspondence Address: Gary K. Price, Esq.;Bowers Harrison, LLP, 25 N.W. Riverside Drive, P.O. Box 1287, Evansville, IN, 47706-1287, US

(21) Appl. No.: 11/637,562

(22) Filed: Dec. 12, 2006

Related U.S. Application Data
(60) Provisional application No. 60/758,913, filed on Jan. 12, 2006.

(51) Int. Cl. B60Q 1/50

(52) U.S. Cl. 340/467

(57) ABSTRACT

A speed reduction warning system that senses vehicle deceleration rate and upon reaching preset limits flashes an illumination device at different rates signaling the operator following the vehicle to the rate of deceleration. The system generally includes a processing unit, an input to the processor that senses deceleration or acceleration rate from the odometer of the vehicle, and an output illumination device. The illumination device includes an indicator that flashes at varying rates controlled by the processor. The processor includes storage having a plurality of ranges stored that are the deceleration rates that the system responds to. In application, with the vehicle in motion, the deceleration or acceleration rate of the vehicle is detected by the input device and supplied to the processor. A value is calculated by the processor representing whether the vehicle is decelerating and if so, the rate of deceleration. If the value is within one of the ranges in storage, the processor sends a corresponding output signal to the illumination device. Once the vehicle is stopped or begins to accelerate the output signal is extinguished by the processor, automatically. The system can further include means such that the indicator of the illumination device activates a selected illumination when the vehicle's anti-lock brake system is applied, or a steady illumination when the vehicle's speed is below 5 mph.

### CROSS REFERENCES TO RELATED APPLICATIONS

U.S. Provisional Application for Patent No. 60/758,913, filed Jan. 12, 2006, with title “Speed Reduction Warning System” which is hereby incorporated by reference. Applicant claims priority pursuant to 35 U.S.C. par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates generally to a vehicle safety warning system, and more particularly to a warning system that improves normal braking signaling by detecting the rate of deceleration and indicating this information through flashing of an illumination device.

2. Brief Description of Prior Art

Most vehicles are equipped with rearward facing visual signaling devices to indicate when the vehicle's braking system is activated. However, a typical brake light signaling is either on (illuminated) or off and does not indicate the degree of vehicle deceleration. It simply indicates that the braking system is activated. This may not be enough information for the operator of a trailing vehicle to safely maneuver to avoid a rear end collision. A higher level of safety can be achieved for one vehicle following another if the operator of the trailing vehicle is better alerted as to the deceleration rate of the front vehicle.

It is known to provide a sensor that senses depression of a brake pedal in a car and in response to the depression of the brake pedal, provides a flashing signal from the rear of the braking car to alert drivers of cars following. It is generally known that a flashing signal can attract more attention than a steady signal. It is known in these systems to make the flash rate of the rear light proportional to the foot applied force on the brake pedal. However, the systems are not proportional to the actual deceleration rate of the vehicle. These systems may give erroneous signals when the brake pads are somewhat worn. A driver may be able to ride the brake pedal slightly and not actually apply the brakes or decelerate at all. This prior art system might also provide a false signal if the driver has a foot on the accelerator at the same time they are braking.

As will be seen from the subsequent description, the preferred embodiments of the present invention overcome the above problems and difficulties of the prior art. There remains a safety need for a system that indicates to the trailing vehicle the degree of vehicle deceleration of the vehicle in front.

### SUMMARY OF THE INVENTION

The present invention is an enhancement to a vehicle safety system that senses vehicle deceleration rate and upon reaching preset limits flashes an illumination device at different rates signaling the operator following the vehicle to the rate of deceleration. The speed reduction warning system of the current invention generally includes a processing unit, an input to the processor that senses deceleration or acceleration rate from the odometer of the vehicle, and an output illumination device. The illumination device includes an indicator that flashes at varying rates controlled by the processor. The processor includes storage having a plurality of ranges stored that are the deceleration rates that the system responds to. In application, with the vehicle in motion, the speed of the vehicle is detected by the input device and supplied to the processor. A value is calculated by the processor representing whether the vehicle is decelerating and if so, the rate of deceleration. If the value is within one of the ranges stored in storage, the processor sends a corresponding output signal to the illumination device. Once the vehicle begins to accelerate the output signal is extinguished by the processor, automatically. The system can further include means such that the indicator of the illumination device activates selected illumination when the vehicle's anti-lock brake system is applied or for example, steady illumination when the vehicle is traveling below 5 mph regardless of whether the vehicle's brakes are on or not.

### BRIEF DESCRIPTION OF THE DRAWINGS

FIG. 1 is a block diagram of the overall system configuration.

### DESCRIPTION OF THE PREFERRED EMBODIMENT

In accordance with the present invention, a speed reduction warning system is disclosed. The speed reduction warning system is directed to a vehicular system that indicates to a trailing vehicle the degree of vehicle deceleration of the vehicle in front. Specifically, the speed reduction warning system of the present invention improves normal braking signaling to the operator of a trailing vehicle by detecting the rate of deceleration and indicating this information through flashing of an illumination device and further, flashing the illumination device at different rates according to the deceleration rate. In the broadest context, the speed reduction warning system of the present invention consists of components configured and correlated with respect to each other so as to attain the desired objective.

It should be noted that the speed reduction warning system that will be described herein is independent of the vehicle's braking system.

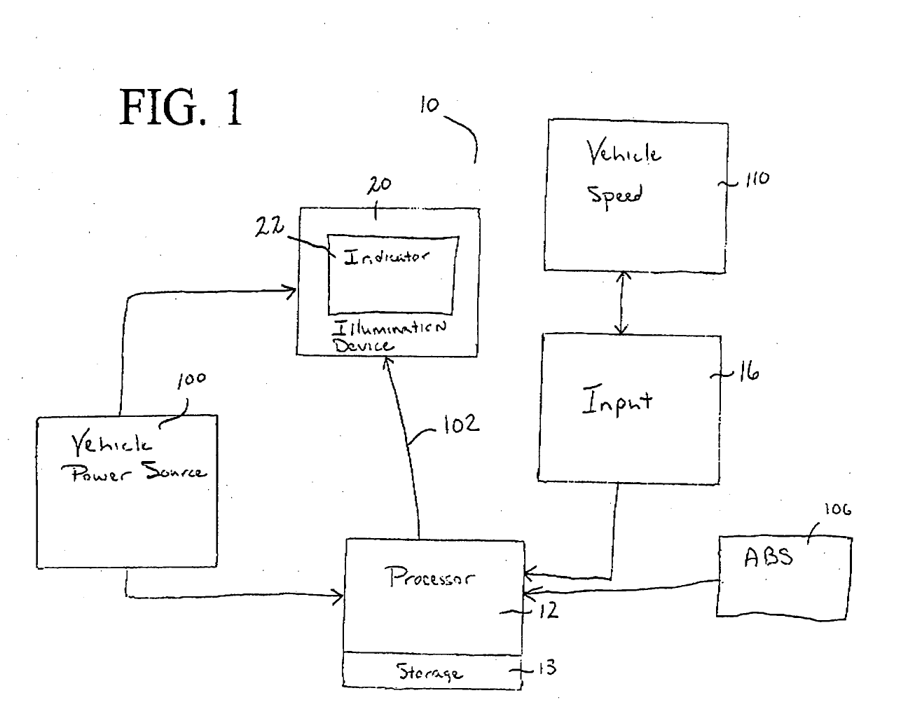

FIG. 1 illustrates the overall system configuration of the speed reduction warning system 10 made in accordance of the present invention. Voltage from the electrical source 100 for the vehicle ignition serves as power for the invention. The system includes a processing unit 12, a (current reading) CR-module 16, and an illumination device 20. As will be described, the CR-module 16 is an input to the processor 12, and the illumination device 20 is output.

The function of the CR-module 16 is to sense deceleration or acceleration rate from a vehicle speed sensor that detects actual vehicle speed directly, such as the odometer 110 or speedometer of the vehicle, which detects a speed of rotation of the vehicle wheels from the transmission, for example. The transducer 16 then converts this rate of acceleration or deceleration from a pulse of electricity having a frequency (Hz) that decreases to a lower frequency as the rate of deceleration increases, into electrical units received as input by the processor 12.

The system 10 includes the illumination device 20 that receives power from the vehicle's power source. The illumination device 20 includes an indicator 22 that flashes at varying rates controlled by the processor 12. The illumination device 20 is preferably oriented so as to be viewed from the rear of the vehicle and preferably mounted high as is practical for maximum visibility.

The processor 12 receives data generated by the CR-module 16 on a controlled time basis such as but not limited to, every 100 milliseconds. It should be understood such reading is continuously taken whether the vehicle is accelerating or decelerating. Once the reading is taken as described, the processor temporarily stores the most recent reading taken (“Current Reading”) and maintains the immediately preceding reading taken (“Previous Reading”). After each reading, the processor 12 then computes a value equal to the Previous Reading minus the Current Reading. It should be understood that if the value is a positive number then the vehicle is decelerating and likewise, if the value is a negative number the vehicle is accelerating. The value is saved in storage 13 of the processor 12.

The storage 13 further includes a plurality of ranges stored that are the deceleration rates that the system 10 responds to. In the preferred embodiment there are six (6) ranges employed however it should be understood that the range levels applied as well as the number of ranges can be modified. Again for illustration purposes only, deceleration rates that the system 10 can respond to: detecting the vehicle speed (mph) has decelerated the equivalent of 0.0-0.25 per tenth of a second; detecting the vehicle speed (mph) has decelerated the equivalent of 0.26-0.40 per tenth of a second; detecting the vehicle speed (mph) has decelerated the equivalent of 0.41-0.60 per tenth of a second; detecting the vehicle speed (mph) has decelerated the equivalent of 0.61-0.80 per tenth of a second; detecting the vehicle speed (mph) has decelerated the equivalent of 0.81-1.0 per tenth of a second; and detecting the vehicle speed (mph) has decelerated the equivalent of 1.1-2.0 per tenth of a second.

The speed reduction warning system 10 operates in the following manner. With the vehicle in motion, the deceleration or acceleration rate of the vehicle is detected by the CR-module 16 and supplied to the processor 12 as described above. When the value is calculated by the processor 12, if the value is within one of the ranges stored in storage 13, the processor 12 sends a corresponding output signal to the illumination device 20. For example, detecting the vehicle speed (mph) has decelerated the equivalent of approximately 0.1-0.25 per tenth of a second, the processor 12 responds by reverting to the “slower deceleration mode” and energizing the illumination device 20 and the indicator 22 to flash at a moderately slow pace. In contrast, detecting the vehicle speed (mph) has decelerated the equivalent of approximately 1.1-2.0 per tenth of a second, the processor 12 responds by reverting to the “fast deceleration mode” and energizing the illumination device 20 and the indicator 22 to rapidly flash. Once the vehicle begins to accelerate the indicator 22 flashing is extinguished by the processor 12, automatically. Alternatively, once the vehicle begins to accelerate or, once the speed of the vehicle is below 5 mph the indicator 22 of the illumination device 20 can activate to a steady illumination, non-flashing.

The system 10 can further include means such that the indicator 22 of the illumination device 20 activates a selected illumination, such as accelerating the indicator 22 flashing when the vehicle's anti-lock brake system 106 is applied.

Although the description above contains many specificities, these should not be construed as limiting the scope of the invention but as merely providing illustrations of some of the presently preferred embodiments of this invention. For example, the processor unit 12 can be a separate component of the vehicle or as preferred, the system 10 can use the computer system manufactured with the vehicle. As such, it is to be understood that the present invention is not limited to the embodiments described above, but encompasses any and all embodiments within the scope of the claims.

It will be obvious to those skilled in the art that modifications may be made to the embodiments described above without departing from the scope of the invention. Thus the scope of the invention should be determined by the claims in the formal application and their legal equivalents, rather than by the examples given.

I claim:

1. A speed reduction warning system comprising:
a processing unit, an input to the processor, and an output, wherein said output is an illumination device, wherein the input includes means to sense deceleration or acceleration rate from an odometer of a vehicle, said illumination device includes an indicator that flashes at varying rates controlled by the processor,
processing means for determining the current rate the vehicle is accelerating or decelerating,
said processor further includes storage for storing a plurality of ranges that are the deceleration rates that the system responds to, wherein when the rate the vehicle is decelerating is within one of the ranges, the processor sends a corresponding output signal to the illumination device.

2. The system as recited in claim 1, further including activation means such that the indicator of the illumination device activates selected illumination when the vehicle's anti-lock brake system is applied.

3. The system as recited in claim 1, further including activation means such that the indicator of the illumination device activates steady illumination when the speed of the vehicle is below 5 mph.

4. The system as recited in claim 1, wherein said input means is a CR-module.

5. The system as recited in claim 4, wherein the processor receives input on a controlled time basis.

6. The system as recited in claim 1, wherein said illumination device is oriented so as to be viewed from the rear of the vehicle and preferably mounted high as is practical for maximum visibility.

7. A speed reduction warning system comprising:
a processing unit, an input to the processor, and an output, wherein said output is an illumination device, wherein the input includes a sensor that directly measures an actual rate of speed of said vehicle, said illumination device includes an indicator that flashes at varying rates controlled by the processor,
said processor further includes storage for storing a plurality of stored value ranges that are the deceleration rates that the system responds to, wherein when the rate of the vehicle is decelerating within one of the ranges, the processor sends a corresponding output signal to the illumination device such that the rate of said flashings vary with the actual rate of change of vehicle speed measured directly.

8. The system as recited in claim 7, wherein said illumination device activates steady illumination when the speed of the vehicle is below 5 mph.

9. The system as recited in claim 8, wherein the sensor is the vehicle odometer.

10. The system as recited in claim 9, wherein the processor receives the input on a controlled time basis and stores a first vehicle speed.

11. The system as recited in claim 10, wherein said processor stores a second vehicle speed and calculates a rate of acceleration of said vehicle by subtracting said second speed from said first speed to obtain a speed difference and divides said speed difference by said controlled time to obtain a vehicle deceleration rate.

12. The system as recited in claim 11, wherein if said deceleration rate is a positive number, said processor will compare said deceleration rate with stored value ranges to determine said corresponding output signal.

13. A speed reduction warning system comprising:
a processing unit, an input to the processor, and an output, wherein said output is an illumination device facing outward from the vehicle, wherein the input includes a sensor that directly measures an actual rate of speed of said vehicle, said illumination device includes an indicator that flashes at varying rates controlled by the processor,
said processor further includes storage for permanently storing a plurality of ranges that are the deceleration rates that the system responds to, wherein when the rate the vehicle is decelerating is within one of the ranges the processor sends a corresponding output signal to the illumination device such that the rate at which the illumination device flashes varies with the actual rate of change of vehicle speed measured directly.

14. The system as recited in claim 13, wherein the processor receives the input at regular time intervals and stores a first vehicle speed.

15. The system as recited in claim 14, wherein said processor stores a second vehicle speed and calculates a rate of acceleration of said vehicle by subtracting said second speed from said first speed to obtain a speed difference and divides said speed difference by said time interval to obtain a rate of vehicle deceleration.

16. The system as recited in claim 15, wherein said illumination device displays steady illumination when the speed of the vehicle is below 5 mph.

17. The system as recited in claim 16, wherein the vehicle speed is taken from the vehicle odometer.

18. The system as recited in claim 17, wherein said processor will compare said deceleration rate with stored value ranges to determine said corresponding output signal to control the rate at which said illumination device flashes.

19. The system as recited in claim 18, wherein the indicator of the illumination device activates a selected illumination when the vehicle's anti-lock brake system is applied.

20. The system as recited in claim 13, wherein said output faces outward from the rear of the vehicle.
